(19) United States
(12) Patent Application Publication
(10) Pub. No.: US 2026/0274688 A1
(43) Pub. Date: Sep. 17, 2026

(54) CHEMICALLY MODIFIED METAL-OXIDE PARTICLES

(71) Applicant: Fujifilm Electronic Materials U.S.A., Inc., N. Kingstown, RI (US)

(72) Inventors: James Johnston, Mesa, AZ (US); Yi Chen, Gilbert, AZ (US); Yannan Liang, Gilbert, AZ (US); Bin Hu, Chandler, AZ (US); Ting-Kai Huang, Queen Creek, AZ (US); Hanyu Fan, Chandler, AZ (US); Tzu-Wei Chiu, Caotun Township (TW); Chun-Fu Chen, Zhubei City (TW); Ching-Hao Chang, Hukou Township (TW); Eric Turner, Phoenix, AZ (US); Yibin Zhang, Gilbert, AZ (US)

(21) Appl. No.: 19/564,548

(22) Filed: Mar. 12, 2026

Related U.S. Application Data
(60) Provisional application No. 63/771,193, filed on Mar. 13, 2025.

(51) Int. Cl. C01B 33/14; C09K 3/14

(52) U.S. Cl. CPC C01B 33/14; C09K 3/1463

(57) ABSTRACT

This disclosure relates to a method for chemically modifying metal oxide particles, including
a) adjusting the pH of a liquid dispersion of metal oxide particles to a pH value where the zeta potential of the metal oxide particles is from at least about −20 mV to at most about 20 mV; and
b) adding a quaternary silane to the liquid dispersion of metal oxide particles to form chemically modified metal oxide particles. This disclosure further relates to polishing compositions including the chemically modified metal oxide particles, and methods of polishing semiconductor substrates using the polishing compositions.

### CROSS-REFERENCE TO RELATED APPLICATION

The present application claims priority to U.S. Provisional Application Ser. No. 63/771,193, filed on Mar. 13, 2025, the contents of which are hereby incorporated by reference in their entirety.

### FIELD OF THE DISCLOSURE

The present disclosure relates generally to chemically modified metal-oxide particles, methods for producing the same, polishing compositions including the same, and methods of polishing semiconductor substrates using compositions that include the chemically modified metal-oxide particles described herein. More particularly, the disclosure relates to metal-oxide particles chemically modified by quaternary silane molecules, methods for producing the same, and chemical mechanical polishing (CMP) compositions that include metal-oxide particles that have been chemically modified by quaternary silane molecules.

### BACKGROUND OF THE DISCLOSURE

Metal-oxide particles are used in a variety of applications. For example, metal-oxide particles find use as components of CMP compositions, resins, paint formulations, optoelectronic materials, toner resin formulations, and cosmetic materials. Surface modification of metal-oxide particles is performed for the general purpose of improving their performance in their application area. Examples include modifications to impart dispersion stability to the particles in a desired fluid/matrix or modifications to alter the reactivity of the particle surfaces (e.g., for catalysis or for directing/targeting groups).

Chemical mechanical polishing compositions are used in the semiconductor industry in a process step called chemical mechanical polishing/planarization (CMP). Along with photolithographic patterning and deposition, CMP is one of the three key enabling process steps in integrated circuit (IC) manufacturing process flow. Modern ICs are built in a parallel fashion, typically, hundreds at a time, on the surface of a common silicon wafer substrate. Photolithography, deposition, CMP and multiple auxiliary steps, are iteratively applied to the wafer surface where the evolving IC structures are located, until the final IC device is finished, and the wafer is ready to be cut into individual dies (chips) for packaging.

One purpose of the CMP step in this technology process flow is to reduce the overburden from the preceding deposition step to a specified layer thickness determined by the integration scheme, and to create a flat wafer surface to enable subsequent photolithography steps. CMP achieves this by polishing the wafer surface in a mechanical polisher. The polishing process involves holding the wafer in a rotating chuck (called the polishing head) and pressing the wafer against a compliant, felt-like polishing pad rotating on the polishing table (the platen), with a pre-selected pressure (the downforce), while applying a metal-oxide abrasive containing slurry (i.e., a chemical mechanical polishing composition) between the wafer surface and the polishing pad.

Some of the generally desired performance metrics for a CMP process based on a specific chemical mechanical polishing composition are: 1) tailorable removal rates related to fab throughput efficiency; 2) high polishing selectivity related to the ability of the CMP process to selectively polish certain surface chemistries of a non-uniform substrate relative to other surface chemistries that are present on or within the non-uniform substrate (e.g., polishing silicon nitride surfaces at a faster rate than silicon oxide surfaces); 3) low levels of defects (scratches, debris, leftover abrasive particles) related to enhancing the final device yield; and 4) uniform material removal across the wafer surface, which is related to the resultant wafer being suitably flat for subsequent photolithography steps. Uniform material removal within the die and across the wafer is also important for within-the-die and within-the-wafer device performance reproducibility and reliability.

Metal-oxide particles are a major component of chemical mechanical polishing slurries and there is a continuing need to find methods of surface modification that can facilitate their dispersion stability and performance across the wide variety of CMP formulations used to polish the substrates currently being used in semiconductor device manufacturing.

### SUMMARY OF THE DISCLOSURE

This summary is provided to introduce a selection of concepts that are further described below in the detailed description. This summary is not intended to identify key or essential features of the claimed subject matter, nor is it intended to be used as an aid in limiting the scope of the claimed subject matter.

In one aspect, this disclosure features a method for chemically modifying metal-oxide particles that includes a) adjusting the pH of a liquid dispersion of metal oxide particles to a pH value where the zeta potential of the metal oxide particles is from at least about-20 mV to at most about 20 mV; and b) adding a quaternary silane to the liquid dispersion of metal oxide particles to form chemically modified metal oxide particles.

In another aspect, this disclosure details chemically modified metal-oxide particle dispersions that are made by the method generally described above.

In another aspect, this disclosure features a composition including metal oxide particles, where the particles comprise a quaternary silane, and where the particles have a mean particle size of from 1 nm to 100 nm.

In another aspect, this disclosure features a polishing composition including at least one metal oxide abrasive; at least one acid or base; and an aqueous solvent, wherein the abrasive has been chemically modified with a quaternary silane compound and has a mean particle size less than about 100 nm; and wherein the polishing composition has a conductivity of at least 15 mS/cm and a zeta potential of at least 20 mV.

Other aspects and advantages of the claimed subject matter will be apparent from the following description and the appended claims.

### DETAILED DESCRIPTION OF THE DISCLOSURE

Embodiments, disclosed herein relate generally to methods for chemically modifying metal-oxide particles and CMP polishing compositions including an abrasive including said modified metal oxide particles. As mentioned above, chemically modifying metal-oxide particles may impart useful properties to the metal-oxide particles that allow them to be used in new applications and more widely in certain applications. Metal oxide particles with no surface modifications (e.g., in their native state) include primarily terminal hydroxyl groups, which lend the particles a negative charge, as determined by zeta-potential measurements, pH values above about 4 (and a positive charge below about 4).

In particular, and with respect to the present disclosure, a metal-oxide particle may have its surface chemically modified with functional groups that allow the particles to have a positively charged surface at a wider range of pH values. Silane coupling treatment is one such surface modification scheme that can alter the surface chemistry of metal-oxide particles. Typically, in silane coupling treatment, an alkoxysilane having a functional group, such as Z—Si(OD)₃ (wherein Z represents a functional group, and D represents an alkyl group), is used as a silane coupling agent. The alkoxy group of alkoxysilane reacts with hydroxyl groups on the particle surface (typically, dehydration-condensation reaction) to form Z—Si—O-particles, whereby the particle surface is modified (in this case, the functional group Z being introduced). The surface modification imparts properties to the particles corresponding to the introduced functional group Z. For example, when an aminosilane (e.g., NH₃—Si(OD)₃ wherein D represents an alkyl group) is used during the silane coupling treatment the introduction of the amino group (NH₃) in the terminus of the particle is known to increase the surface charge of the particles and increase the pH region that shows positive zeta potential.

However, chemical modification of metal-oxide particles with aminosilane groups is still only able to achieve particles that have an isoelectric point (i.e., a pH value where the particles have a positive zeta-potential below the pH value and a negative zeta-potential above the pH value) approaching 7. Thus, chemical modification with silane compounds that possess a stronger cationic character is necessary to expand the operable pH window for cationically charged particles. Quaternary ammonium silanes and quaternary phosphonium silanes possess a stronger cationic character than aminosilanes but have been difficult to work with when used in a silane coupling treatment with metal-oxide particles because their strong positive charge can effectively bridge metal oxide particles hydroxyl surfaces causing unwanted particle growth/fusion and they can also react via an intermolecular reaction to form oligomeric silane species that can effectively gel the reaction medium rendering it useless. Indeed, these issues are so prevalent that various groups have developed complex functionalization schemes involving intermediate reactive linking groups and/or dilute solution reactions that then require an energy inefficient concentration step to produce a usable form of chemically modified metal-oxide particles.

Significantly, the present inventors have developed a route to the direct chemical modification of metal-oxide particles with quaternary ammonium silanes or quaternary phosphonium silanes with minimal increases in mean particle size (MPS) and at high concentration yield, thereby avoiding a costly and time-consuming concentration step. This method will be described in detail in the embodiments that follow.

This disclosure features a method for chemically modifying metal-oxide particles that includes a) adjusting the pH of a liquid dispersion of metal oxide particles to a pH value where the zeta potential of the metal oxide particles is from at least about-20 mV to at most about 20 mV; and b) adding a quaternary silane to the liquid dispersion of metal oxide particles to form chemically modified metal oxide particles. In some embodiments, the liquid dispersion can be an aqueous dispersion.

In some embodiments, the metal oxide particles can include silica, titania, alumina, ceria, zirconia, or mixtures thereof. In some embodiments, the metal oxide particles include colloidal silica, fumed silica, core-shell particles comprising a silica shell, or mixtures thereof.

In some embodiments, the metal oxide particles in the liquid dispersion can have a mean particle size of from at least about 1 nm (e.g., at least about 10 nm, at least about 25 nm, at least about 50 nm, at least about 75 nm, at least about 100 nm, at least about 250 nm, at least about 500 nm, at least about 750 nm, at least about 1000 nm, at least about 1500 nm, at least about 2000 nm, or at least about 2500 nm) to at most about 5000 nm (e.g., at most about 4500 nm, at most about 4000 nm, at most about 3500 nm, at most about 3000 nm, at most about 2500 nm, at most about 2000 nm, at most about 1500 nm, at most about 1000 nm, at most about 750 nm, at most about 500 nm, at most about 250 nm, at most about 150 nm, or at most about 100 nm).

In some embodiments, the liquid dispersion of metal oxide particles can have a weight percent of from at least about 1% (e.g., at least about 2.5%, at least about 5%, at least about 7.5%, at least about 10%, at least about 12.5%, at least about 15%, at least about 20%, or least about 25%) by weight of the metal oxide particles to at most about 50% (e.g., at most about 45%, at most about 40%, at most about 35%, at most about 30%, at most about 25%, or at most about 20%) by weight of metal oxide particles. In some applications, it may be preferable to have a concentration of at least about 20% by weight of metal oxide particles in the liquid dispersion so that (1) a high concentration of silica particles is present to react with the quaternary silane compound and potentially reduce the likelihood of self-hydrolysis and gelling and (2) a highly concentrated final product of chemically modified metal oxide particles is produced and needs minimal further processing before use (e.g., no post-modification concentrating steps).

In some embodiments, the zeta potential of the metal oxide particles can be, after adjusting the pH, and prior to adding the quaternary silane, from at least about-20 mV to at most about 20 mV. For example, the zeta potential of the metal oxide particles after adjusting the pH, and prior to adding the quaternary silane, can be at least about-20 mV (e.g., at least about-15 mV, at least about-10 mV, or at least about-5 mV) to at most about 20 mV (e.g., at most about 15 mV, at most about 10 mV, or at most about 5 mV). In one or more embodiments, the zeta-potential of the metal oxide particles may preferably be between about −5 mV and about 10 mV. In one or more embodiments, the zeta potential of the metal oxide particles can be, after adjusting the pH, and prior to adding the quaternary silane, about 0.001 mV (e.g., at least about 0.005 mV, at least about 0.01 mV, at least about 0.05 mV, at least about 0.1 mV, at least about 0.2 mV, at least about 0.5 mV, at least about 1 mV, at least about 2.5 mV, at least about 5 mV, at least about 10 mV, at least about 15 mV,) to at most about 20 mV (e.g., at most about 15 mV, at most about 10 mV, or at most about 5 mV). Without wishing to be bound by theory, it is believed that a zeta potential for the metal oxide particles ranging around neutral (i.e., no more negative than-5 mV) to positively charged is important for creating a favorable environment for the quaternary silane to react efficiently with the metal oxide particle surface. Indeed, it may be particularly preferable for the zeta potential to be positive. For example, the quaternary silane has a terminal group that is positively charged (i.e., the quaternary group) and the other terminal group, which ultimately reacts with the surface of the metal oxide particles, is more negative in charge. Thus, by adjusting the zeta potential of the metal oxide particles to near neutral or positive a favorable charge-based interaction between the surface of the metal oxide particles and the quaternary silane reactant species is achieved and the surface hydrolysis can be more effectively directed. Additionally, it is believed that because of the directional nature of the interaction the charge-based interaction is highly preferential over self-hydrolysis once the quaternary silane is added to an aqueous solution of metal oxide particles, which is particularly important when a high concentration of quaternary silane (e.g., a solution of greater than 20 wt. %) is added to the liquid dispersion of metal oxide particles. Avoidance of self-hydrolysis is necessary to prevent or reduce the formation of oligomeric silane/silicate species that can cause gelling of the reaction medium and/or lead to uncontrolled growth of the starting metal oxide particles due to primary particle bridging.

Commonly available dispersions of non-modified metal oxide particles typically contain particles with zeta-potential values of about-25 mV or more negative or at least 25 mV or more positive because these are values where the particle surfaces are considered highly charged and when the particles in a dispersion are highly charged the dispersion can be more stable and less settling or agglomeration occurs due to the highly charged particles effectively electrostatically avoiding each other. Thus, the method described herein of adjusting the pH to achieve a more neutral or positive zeta-potential, effectively destabilizing the dispersion of metal oxide particles, in order to form a more favorable reaction environment for the quaternary silane compound to react with the metal oxide particle is counterintuitive. However, once the metal oxide particles are chemically modified with the quaternary silane compound, the formerly destabilized dispersion is highly stable due to the charged quaternary group providing sufficient electrostatic repulsion between the particles.

In some embodiments, the liquid dispersion of non-modified metal oxide particles can have a pH from at least about 1 (e.g., at least about 1.5, at least about 2, at least about 2.5, at least about 3, at least about 3.5, or at least about 4) to at most about 7 (e.g., at most about 6.5, at most about 6, at most about 5.5, at most about 5, at most about 4.5, at most about 4, at most about 3.5) after the adjusting. In one or more embodiments, the liquid dispersion of metal oxide particles has its pH adjusted to below the isoelectric point of the non-modified metal oxide particles in the liquid dispersion. Without wishing to be bound by theory, non-chemically modified metal oxide particles are most likely to have a near neutral or more positive zeta potential under acidic conditions as a result of the large concentration of protons in the solution interacting with the commonly oxygen/oxide rich particle surface. Further, when the pH is adjusted below the isoelectric point of the non-modified metal oxide particles the functionalization reaction may proceed in a more controlled manner and reduce the likelihood of unwanted side reactions (e.g., self-hydrolysis of the silane or particle bridging). However, many factors determine the isoelectric point of the particles in the dispersion (e.g., the chemical composition, concentration, particle size, etc.) and adjusting the pH of the liquid dispersion is necessary to achieve the desired zeta potential of the metal oxide particles in the liquid dispersion and the reaction environment benefits (described above) that result from having metal oxide particles with the described zeta potential.

In some embodiments, an acid can be added to the liquid dispersion of metal oxide particles during the adjusting to achieve the pH necessary to be lower than the isoelectric point of the source non-modified metal oxide particles and/or to have the desired zeta potential reading for the metal oxide particles. Further, in some embodiments it may take multiple adjustments with acid to achieve a stable pH reading. In one or more embodiments, the acid can be selected from organic acids or inorganic acids. For example, the acid can be selected from the group consisting of formic acid, acetic acid, malonic acid, citric acid, propionic acid, malic acid, adipic acid, succinic acid, lactic acid, oxalic acid, hydroxyethylidene diphosphonic acid, 2-phosphono-1,2,4-butane tricarboxylic acid, aminotrimethylene phosphonic acid, hexamethylenediamine tetra(methylenephosphonic acid), bis(hexamethylene)triamine phosphonic acid, amino acetic acid, peracetic acid, phenoxyacetic acid, glycine, bicine, diglycolic acid, glyceric acid, tricine, histidine, phenylalanine, proline, aspartic acid, glutamic acid, arginine, benzoic acid, nitric acid, sulfuric acid, sulfurous acid, phosphoric acid, phosphonic acid, hydrochloric acid, periodic acid, tartaric acid, boric acid, phthalic acid, and mixtures thereof.

In some embodiments, the quaternary silane can be a silane compound that includes an ammonium group or a phosphonium group. The ammonium group can be a terminal ammonium group. The phosphonium group can be a terminal phosphonium group. In some embodiments, the quaternary silane is selected from the group consisting of n-trimethoxysilylpropyl-n,n,n-trimethylammonium chloride, n-triethoxysilylpropyl-n,n,n-trimethylammonium chloride, n-trimethoxysilylethyl-n,n,n-trimethylammonium chloride, n-triethoxysilylethyl-n,n,n-trimethylammonium chloride, n-trimethoxysilylpropyl-n,n,n-triethylammonium chloride, n-triethoxysilylpropyl-n,n,n-triethylammonium chloride, n-trimethoxysilylethyl-n,n,n-tripropylammonium chloride, n-triethoxysilylethyl-n,n,n-tripropylammonium chloride, octadecyldimethyl (3-trimethoxysilylpropyl) ammonium chloride, n,n-didecyl-n-(3-trimethoxysilylpropyl) ammonium chloride, and mixtures thereof. Quaternary phosphonium silane analogs of the above quaternary ammonium silane compounds are also envisioned, and their chemical name would be arrived at by simply substituting “phosphonium” for “ammonium.”

In some embodiments, the quaternary silane compound can be added to the liquid dispersion of metal oxide particles as a liquid in pure form (e.g., no diluent) or as a water miscible solution after being dissolved in a water miscible solvent. In some embodiments, the quaternary silane compound is available commercially as a solution of the compound dissolved in a water miscible solvent. In other embodiments, the quaternary silane may be a solid that would need to be dissolved in a water miscible solvent to form a well dispersed reactant. In some embodiments, the water miscible solvent can be selected from the group consisting of methanol, ethanol, propanol, iso-propanol, butanol, ethylene glycol, propylene glycol, acetone, toluene, dimethylformamide, tetrahydrofuran, or mixtures thereof.

In embodiments, where a water miscible solution of the quaternary silane is utilized, the quaternary silane can be from at least about 0.1% (e.g., at least about 0.5%, at least about 1%, at least about 2.5%, at least about 5%, at least about 10%, at least about 15%, at least about 20%, at least about 25%, at least about 30%, at least about 35%, at least about 40%, or at least about 45%) by weight of the water miscible solution to at most about 75% (e.g., at most about 70%, at most about 65%, at most about 60%, at most about 55%, at most about 50% at most about 45%, at most about 40%, at most about 35%, at most about 30%, at most about 25%, or at most about 20%) by weight of the water miscible solution. Without being bound by theory, it is believed that adding a high weight percent of quaternary silane (e.g. at least about 20 wt. %) is preferable to ensure an efficient surface modification reaction, to reduce the amount of organic solvents used, and avoid significant dilution of the weight percent of the functionalized abrasive solution.

In some embodiments, adding the quaternary silane can be performed while agitating the liquid dispersion of metal oxide particles. In one or more embodiments, adding the quaternary silane to the liquid dispersion of metal oxide particles may be done at about room temperature (e.g., about 20-22° C.) and/or while the liquid dispersion is heated (e.g., from about 30-90° C.). In some embodiments, adding the quaternary silane can be performed at a consistent rate. For example, in some embodiments, the water miscible solution containing the quaternary silane can be added to the liquid dispersion of metal oxide particles at a rate of at least one gram per minute (e.g., at least about two grams per minute, at least about four grams per minute, at least about five grams per minute, at least about seven grams per minute, or at least about ten grams per minute) to at most about fifty grams per minute (e.g., at most about forty five grams per minute, or at most about forty grams per minute, or at most about thirty five grams per minute, or at most about thirty grams per minute, or at most about twenty five grams per minute, or at most about twenty grams per minute). In some embodiments, it may be useful to add the water miscible solution containing the quaternary silane compound to the liquid dispersion of metal oxide particles at a rate that is a function of the volume of the liquid dispersion of metal oxide particles. For example, in some embodiments, the water miscible solution containing the quaternary silane can be added to the liquid dispersion of metal oxide particles at a rate of at least 0.01% of the weight of the liquid dispersion of metal oxide particles per minute (e.g., at least 0.03% of the weight of the liquid dispersion, or at least 0.05% of the weight of the liquid dispersion, or at least 0.08% of the weight of the liquid dispersion, or at least 0.1% of the weight of the liquid dispersion, or at least 0.15% of the weight of the liquid dispersion, or at least 0.2% of the weight of the liquid dispersion, or at least 0.5% of the weight of the liquid dispersion, or at least 1% of the weight of the liquid dispersion) to at most about 5% of the weight of the liquid dispersion of metal oxide particles per minute (e.g., at most about 4.5% of the weight of the liquid dispersion, or at most 4% of the weight of the liquid dispersion, or at most 3.5% of the weight of the liquid dispersion, or at most 3% of the weight of the liquid dispersion, or at most 2.5% of the weight of the liquid dispersion, or at most 2% of the weight of the liquid dispersion, or at most about 1.5% of the weight of the liquid dispersion, or at most 1% of the weight of the liquid dispersion, or at most 0.5% of the weight of the liquid dispersion). For example, when the weight of the dispersion of metal oxide particles is 1000 g, then the rate of addition of the solution containing quaternary silane could be between 0.1 g per minute and 50 g per minute. In some embodiments, from at least about 0.1% (e.g., at least about 0.5%, at least about 1%, at least about 2.5%, at least about 5%, at least about 7.5%, at least about 10%, or at least about 12.5%) by weight of quaternary silane to at most about 20% (e.g., at most about 17.5%, at most about 15%, at most about 12.5%, or at most about 10%) by weight of quaternary silane is added to the liquid dispersion with respect to the weight of metal oxide particles in the liquid dispersion. For example, when the weight of the metal oxide particles in the dispersion is 100 g, then amount of quaternary silane added to the dispersion could be between 0.1 g and 20 g. Without being bound by theory, it is believed that a roughly 1:1 ratio of quaternary silane molecules to oxygenated groups on the surface of the metal oxide particles (e.g., silanol groups on silica particles) is ideal to provide enough quaternary silane to effectively functionalize the surface of the particle, while not providing too much quaternary silane leading to self-hydrolysis and the resulting gelling and particle growth.

In some embodiments, the chemically modified metal oxide particles can have an isoelectric point of at least about 7 (e.g., at least about 7.5, at least about 8, at least about 8.5, at least about 9, or at least about 9.5) to an isoelectric point of at most about 11.5 (e.g., at most about 11, at most about 10.5, at most about 10, at most about 9.5, or at most about 9, or at most about 8.5, or at most about 8, or at most about 7.5). Without wishing to be bound by theory, it is believed that once the quaternary silane compound is chemically attached to the surface of the metal oxide particles the isoelectric point is increased from an acidic range to an alkaline range due to the positive charge of the quaternary group. This change in isoelectric point can prove valuable in expanding the applications where the metal oxide particles may be used.

In some embodiments, the chemically modified metal oxide particles can have a mean particle size (MPS) within about 1% (e.g., about 2.5%, about 5%, about 7.5%, about 10%, or about 12.5%) of the mean particle size of the starting metal oxide particles (i.e., non-modified particles) to within about at most 20% (e.g., at most about 17.5%, at most about 15%, at most about 12.5%, at most about 10%, at most about 7.5, or at most about 5%) of the mean particle size of the starting metal oxide particles. It is believed that the method detailed herein can uniquely chemically modify metal oxide particles with quaternary silane compounds without a large increase in the size of the starting metal oxide particles. Control over the resulting size of the particles is important for many applications and allows the chemically modified particles to be reliably created with well-defined and known properties.

In some embodiments, the weight percent of the chemically modified particles after adding the quaternary silane compound can be at most 5% (e.g., at most about 4.5%, at most about 4%, at most about 3.5%, at most about 3%, at most about 2.5%, at most about 2%, at most about 1.5%, at most about 1.0%, or at most about 0.5%) different from the weight percent of the metal oxide particles in the initial liquid dispersion.

This disclosure further features a chemically modified metal oxide particle dispersion made by the methods described herein. In some embodiments, the chemically modified metal oxide particles in the dispersion can have a mean particle size of from at least about 1 nm (e.g., at least about 2.5 nm, at least about 5 nm, at least about 7.5 nm, at least about 10 nm, at least about 12.5 nm, at least about 15 nm, at least about 17.5 nm, at least about 20 nm, at least about 25 nm, at least about 30 nm, at least about 35 nm, at least about 40 nm, at least about 45 nm, at least about 50 nm, or at least about 55 nm) to at most about 100 nm (e.g., at most about 95 nm, at most about 90 nm, at most about 85 nm, at most about 80 nm, at most about 75 nm, at most about 70 nm, at most about 65 nm, at most about 60 nm, at most about 55 nm, at most about 50 nm, or at most about 45 nm).

This disclosure further features compositions of metal oxide particles comprising a quaternary silane and having a mean particle size of from 1 nm to 100 nm. In some embodiments, the particles comprise silica, titania, alumina, ceria, zirconia, or mixtures thereof. In some embodiments, the metal oxide particles comprise colloidal silica, fumed silica, core-shell particles comprising a silica shell, or mixtures thereof. In some embodiments, the quaternary silane is a silane compound that has a terminal ammonium group or a terminal phosphonium group. In some embodiments, the composition is in the form of a liquid dispersion.

The chemically modified metal oxide particles described herein can be used in polishing compositions that are used in the semiconductor industry in a process step called chemical mechanical polishing/planarization (CMP). For example, a chemical mechanical polishing composition including the chemically modified metal oxide particles described herein can be used in a method for polishing a substrate surface. The method can include contacting a substrate with the composition including the chemically modified metal oxide particles described herein. The method can include contacting a wafer having a surface comprising Si, SiN, SiC, SiOC, low-K dielectric (e.g., Black Diamond), TiN, W, Ru, Mo, TEOS, Cu, TaN, Co, polymeric surfaces (i.e., organic films), or p-Si with the composition including the chemically modified metal oxide particles described herein. In one or more embodiments, a solution of chemically modified metal oxide particles obtained from the functionalization reaction can be used directly to formulate a CMP polishing composition (e.g., without further filtration or processing). However, in some embodiments, a post-synthesis filtration or ion-exchange process may be implemented prior to using the solution of chemically modified metal oxide particles in a polishing composition.

As mentioned above, this disclosure further features a polishing composition useful in CMP. The quaternary silane modification of the metal oxide particles renders the particles with a strong positive charge across a much broader pH range than non-modified metal oxide particles and even commercially available particles that have been modified with aminosilane compounds. This, in turn, allows for use of the benefits of the positively charged particles with a variety of substrates and application areas that may otherwise have been off limits due to the narrow pH range where the prior particles maintained their positive charge. Further, the ability to have a highly positive zeta potential at pH values of 7 and above allows for the provision of stable polishing compositions described herein in a highly concentrated form (as indicated by conductivity values above about 15 mS/cm), which tend to be more cost-effective (e.g., less shipping and storing cost). The polishing compositions including an abrasive including the metal oxide particles described herein exhibit a high magnitude zeta potential, which creates stronger electrostatic repulsion between abrasive particles, improves dispersion stability, and prevents particle aggregation. This contributes to maintaining uniform abrasive action, avoids large particle defects, and improves polishing performance in certain applications.

The polishing composition includes at least one abrasive including metal oxide particles; at least one acid or base; and an aqueous solvent, wherein the metal oxide particles have been chemically modified with a quaternary silane compound and have a mean particle size less than about 100 nm; and wherein the polishing composition has a conductivity of at least about 15 mS/cm and a zeta potential of at least about 20 mV. In some embodiments, the polishing composition consists of the at least one abrasive including metal oxide particles, the at least one acid or base, and the aqueous solvent. In some embodiments, the polishing composition consists essentially of the at least one abrasive including metal oxide particles, the at least one acid or base, and the aqueous solvent. A polishing composition that consists essentially of the at least one abrasive including metal oxide particles, the at least one acid or base, and the aqueous solvent can be a composition that includes less than 1 wt. % (e.g., less than 0.9% wt. %, less than 0.8% wt. %, less than 0.7% wt. %, less than 0.6% wt. %, less than 0.5% wt. %, less than 0.4% wt. %, less than 0.3% wt. %, less than 0.2% wt. %, or less than 0.1% wt. %) of other components.

In some embodiments, the polishing composition is substantially free of dispersants. In some embodiments, the polishing composition is free of dispersants. In some embodiments, the dispersant is selected from the group consisting of polymers (e.g., nonionic, cationic, anionic, or water-soluble polymers), surfactants (e.g., cationic surfactants, anionic surfactants, non-polymeric surfactants, or nonionic surfactants), and mixtures thereof. Examples of anionic surfactants include carboxylate surfactants, sulfonate surfactants, phosphate surfactants, sulfate surfactants and mixtures thereof. In some cases, the anionic surfactant may include polyoxyethylene groups separating the anionic head group from an alkyl tail group. Examples of non-ionic surfactants include polysorbate (e.g., polysorbate 20 (sorbitan monolaurate), polysorbate 40, polysorbate 60 (sorbitan monostearate), polysorbate 65, and polysorbate 80 (sorbitan monooleate)) and polyetheramine (e.g., triethylene glycol diamine or poly(ethyleneoxy)amine). Examples of cationic surfactants include tetradecyltrimethylammonium bromide, dodecyltrimethylammonium bromide, alkylammonium acetates, primary, secondary, or tertiary alkylamines, and mixtures thereof. Examples of polymers include water-soluble, non-ionic polymers selected from the group consisting of polyoxyethylene sorbitan monolaurate, polyoxyethylene sorbitan monopalminate, polyoxyethylene sorbitan monostearate, polyoxyethylene sorbitan monooleate, and mixtures thereof. Examples of polymers further include water-soluble, anionic polymers formed from one or more monomers selected from the group consisting of (meth)acrylic acid, maleic acid, acrylic acid, acrylamide, malic acid, methacrylic acid, vinyl phosphonic acid, vinyl phosphoric acid, vinyl sulfonic acid, allyl sulfonic acid, styrene sulfonic acid, acrylamidopropyl sulfonic acid, phosphonic acid, phosphoric acid, butadiene/maleic acid, caprolactam, etherimide, 2-ethyl-2-oxazoline, N-iso-propylacrylamide, sodium phosphinite, and co-formed products thereof, and sodium, potassium, and ammonium salts thereof. For example, the water soluble polymer can be selected from the group consisting of poly(4-styrenylsulfonic) acid (PSSA), polyacrylic acid (PAA), poly(vinylphosphonic acid) (PVPA), poly(2-acrylamido-2-methyl-1-propanesulfonic acid), poly(N-vinylacetamide) (PNVA), polyethylenimine (PEI), anionic poly(methyl methacrylate) (PMMA), anionic polyacrylamide (PAM), polyaspartic acid (PASA), anionic poly(ethylene succinate) (PES), anionic polybutylene succinate (PBS), poly(vinyl alcohol) (PVA), 2-propenoic acid copolymer with 2-methyl-2-((1-oxo-2-propenyl)amino)-1-propanesulfonic acid monosodium salt and sodium phosphinite, 2-propenoic acid copolymer with 2-methyl-2-((1-oxo-2-propenyl)amino)-1-propanesulfonic acid monosodium salt and sodium hydrogen sulfite sodium salt, 2-acrylamido-2-methyl-1-propanesulfonic acid-acrylic acid copolymer, poly(4-styrenesulfonic acid-co-acrylic acid-co-vinylphosphonic acid) terpolymer, and mixtures thereof. In some embodiments, the polishing composition is free of any combination of polymers and surfactants described above. In some embodiments, the surfactant can be A polishing composition that is “substantially free” from dispersants refers to a polishing composition where a dispersant is not intentionally added into the composition. In some embodiments, the polishing composition described herein can have at most about 2000 ppm (e.g., at most about 1000 ppm, at most about 500 ppm, at most about 250 ppm, at most about 100 ppm, at most about 50 ppm, at most about 10 ppm, or at most about 1 ppm) of a dispersant. In some embodiments, the polishing composition described herein can be completely free of dispersants. Without being bound by theory, it is believed that the chemical functionalization of the abrasive particles confers a surprising stability to polishing compositions they are included in, particularly, high conductivity polishing compositions (e.g., conductivity greater than about 15 mS/cm) and no dispersants are necessary to prevent particle aggregation or settling.

In some embodiments, the metal oxide particles can include silica, titania, alumina, ceria, zirconia, or mixtures thereof. In some embodiments, the metal oxide particles include colloidal silica, fumed silica, core-shell particles comprising a silica shell, or mixtures thereof.

In some embodiments, the metal oxide abrasive can have a mean particle size of from at least about 1 nm (e.g., at least about 2.5 nm, at least about 5 nm, at least about 7.5 nm, at least about 10 nm, at least about 12.5 nm, at least about 15 nm, at least about 17.5 nm, at least about 20 nm, at least about 25 nm, at least about 30 nm, at least about 35 nm, at least about 40 nm, at least about 45 nm, at least about 50 nm, or at least about 55 nm) to at most about 100 nm (e.g., at most about 95 nm, at most about 90 nm, at most about 85 nm, at most about 80 nm, at most about 75 nm, at most about 70 nm, at most about 65 nm, at most about 60 nm, at most about 55 nm, at most about 50 nm, or at most about 45 nm).

In some embodiments, the metal oxide particles can be from about 1% (e.g., at least about 2.5%, at least about 5%, at least about 7.5%, at least about 10%, at least about 12.5%, at least about 15%, at least about 20%, or least about 25%) by weight of the metal oxide particles to at most about 40% (e.g., at most about 35%, at most about 30%, at most about 25%, or at most about 20%) by weight of a concentrated polishing composition. In one or more embodiments, the concentrated polishing composition may be diluted with water (e.g., deionized water) up to 10×(e.g., up to 8×, or up to 6×, or up to 4×, or up to 2×) to form a point of use (POU) polishing composition. Without wishing to be bound by theory, it is believed that the metal oxide particles described herein can be advantageously used at substantially lower concentrations in CMP polishing compositions in comparison to conventional abrasive particles.

In some embodiments, the acid may be an inorganic acid or an organic acid. In some embodiments, the acid is selected from the group consisting of formic acid, acetic acid, malonic acid, citric acid, propionic acid, malic acid, adipic acid, succinic acid, lactic acid, oxalic acid, hydroxyethylidene diphosphonic acid, 2-phosphono-1,2,4-butane tricarboxylic acid, aminotrimethylene phosphonic acid, hexamethylenediamine tetra(methylenephosphonic acid), bis(hexamethylene)triamine phosphonic acid, amino acetic acid, peracetic acid, phenoxyacetic acid, glycine, bicine, diglycolic acid, glyceric acid, tricine, histidine, phenylalanine, proline, aspartic acid, glutamic acid, arginine, benzoic acid, nitric acid, sulfuric acid, sulfurous acid, phosphoric acid, phosphonic acid, hydrochloric acid, periodic acid, tartaric acid, boric acid, phthalic acid, and mixtures thereof. In one or more embodiments, a single acid may be used in polishing compositions according to the present invention.

In one or more embodiments, the base may be an inorganic base or an organic base. In some embodiments, the base is selected from the group consisting of ammonium hydroxide, sodium hydroxide, potassium hydroxide, cesium hydroxide, monoethanolamine, diethanolamine, triethanolamine, methylethanolamine, methyldiethanolamine tetrabutylammonium hydroxide, tetrapropylammonium hydroxide, tetraethylammonium hydroxide, tetramethylammonium hydroxide, ethyltrimethylammonium hydroxide, diethyldimethylammonium hydroxide, dimethyldipropylammonium hydroxide, benzyltrimethylammonium hydroxide, tris(2-hydroxyethyl)methylammonium hydroxide, choline hydroxide, trimethonium dihydroxide, tetramethonium dihydroxide, pentamethonium dihydroxide, hexamethonium dihydroxide, heptamethonium dihydroxide, octamethonium dihydroxide, nonamethonium dihydroxide, decamethonium dihydroxide, and any combinations thereof. In one or more embodiments, a single base may be used in polishing compositions according to the present invention.

In one or more embodiments, the acid or base can be present in a polishing composition described herein in an amount of from at least about 0.005 wt % (e.g., at least about 0.01 wt %, at least about 0.05 wt %, at least about 0.1 wt %, at least about 0.2 wt %, or at least about 0.4 wt %) to at most about 0.5 wt % (e.g., at most about 0.4 wt %, at most about 0.3 wt %, at most about 0.2 wt %, or at most about 0.1 wt %) based on the total weight of the composition. In some embodiments, the polishing composition includes at least one acid and at least one base. In embodiments, where both an acid and a base are present in the polishing composition the weight percents described above may apply to each singly. Without being bound by theory, the acid or base can be added in an amount sufficient to adjust the pH of a polishing composition to the desired value and/or to target a specific substrate surface.

In one or more embodiments, the aqueous solvent can be present in a polishing compositions described herein (e.g., as a liquid medium or carrier) in an amount of from at least about 50 wt % (e.g., at least about 55 wt %, at least about 60 wt %, at least about 65 wt %, at least about 70 wt %, or at least about 75 wt %) to at most about 99.9 wt % (e.g., at most about 99.5 wt %, at most about 99 wt %, at most about 97 wt %, at most about 95 wt %, or at most about 90 wt %) based on the total weight of the composition. In some embodiments, the aqueous solvent can be water.

In one or more embodiments, the polishing composition described herein can include at least one (e.g., two or three) corrosion inhibitor. In one or more embodiments, the polishing composition described herein can include a single corrosion inhibitor. In one or more embodiments, the corrosion inhibitor is a heterocyclic compound, such as a heterocyclic compound containing at least two (e.g., three or four) ring nitrogen atoms. In one or more embodiments, the corrosion inhibitor is an azole, such as a triazole (e.g., a benzotriazole), a tetrazole, a pyrazole, an imidazole, or a thiadiazole, each of which is optionally substituted with one or more substituents (e.g., halo, amino, C₁-C₁₀ alkyl, C₁-C₁₀ arylalkyl, C₁-C₁₀ haloalkyl, or aryl). In one or more embodiments, the corrosion inhibitor is a purine (e.g., 9H-purine, xanthine, hypoxanthine, guanine, and isoguanine) or a pyrimidine (e.g., cytosine, thymine, and uracil). In one or more embodiments, the corrosion inhibitor is selected from the group consisting of tetrazole, benzotriazole, tolyltriazole, 1-methyl benzotriazole, 4-methyl benzotriazole, 5-methyl benzotriazole, 1-ethyl benzotriazole, 1-propyl benzotriazole, 1-butyl benzotriazole, 5-butyl benzotriazole, 1-pentyl benzotriazole, 1-hexyl benzotriazole, 5-hexyl benzotriazole, 5,6-dimethyl benzotriazole, 5-chloro benzotriazole, 5,6-dichloro benzotriazole, 1-(chloromethyl)-1H-benzotriazole, chloroethyl benzotriazole, phenyl benzotriazole, benzyl benzotriazole, aminotriazole, aminobenzimidazole, pyrazole, imidazole, aminotetrazole, adenine, xanthine, cytosine, thymine, uracil, 9H-purine, guanine, isoguanine, hypoxanthine, benzimidazole, thiabendazole, 1,2,3-triazole, 1,2,4-triazole, 1-hydroxybenzotriazole, 2-methylbenzothiazole, 2-aminobenzimidazole, 2-amino-5-ethyl-1,3,4-thiadiazole, 3,5-diamino-1,2,4-triazole, 3-amino-5-methylpyrazole, 4-amino-4H-1,2,4-triazole, and combinations thereof. Without wishing to be bound by theory, it is believed that the azole compounds can be used as a corrosion inhibitor in the polishing compositions described herein to reduce the removal of certain materials (e.g., metals or dielectric materials) during the polishing process.

In one or more embodiments, the corrosion inhibitor is included in the polishing composition in an amount from about 0.001% to about 5% by weight of the composition. For example, the corrosion inhibitor can be at least about 0.001% (e.g., at least about 0.002%, at least about 0.004%, at least about 0.006%, at least about 0.008%, at least about 0.01%, at least about 0.02%, at least about 0.04%, at least about 0.06%, or at least about 0.08%) by weight to at most about 5% (e.g., at most about 4%, at most about 3%, at most about 2%, at most about 1%, at most about 0.8%, at most about 0.6%, at most about 0.4%, at most about 0.2%, or at most about 0.1%) by weight of the polishing composition described herein.

The pH value of the polishing compositions of the present application is not inherently limited. However, the benefits of using the chemically modified abrasive particles in a polishing composition may be particularly evident at pH values above about 5 (i.e., the current isoelectric point for widely available commercial particles). In one or more embodiments, the polishing compositions described herein can have a pH of at least about 5 (e.g., at least about 5.5, at least about 6, at least about 6.5, at least about 7, at least about 7.5, at least about 8, at least about 8.5, or at least about 9) to at most about 12 (e.g., at most about 11.5, at most about 11, at most about 10.5, at most about 10, or at most about 9.5). Without wishing to be bound by theory, it is believed that a polishing composition having a pH of at least about 5 contributes to a high magnitude zeta potential (e.g., at least about 20 mV), which improves dispersion stability and has been a pH range where it has been difficult to maintain said positive charge.

In some embodiments, the quaternary silane compound can be a silane compound that includes an ammonium group or a phosphonium group. The ammonium group can be a terminal ammonium group. The phosphonium group can be a terminal phosphonium group. In some embodiments, the quaternary silane is selected from the group consisting of n-trimethoxysilylpropyl-n,n,n-trimethylammonium chloride, n-triethoxysilylpropyl-n,n,n-trimethylammonium chloride, n-trimethoxysilylethyl-n,n,n-trimethylammonium chloride, n-triethoxysilylethyl-n,n,n-trimethylammonium chloride, n-trimethoxysilylpropyl-n,n,n-triethylammonium chloride, n-triethoxysilylpropyl-n,n,n-triethylammonium chloride, n-trimethoxysilylethyl-n,n,n-tripropylammonium chloride, n-triethoxysilylethyl-n,n,n-tripropylammonium chloride, octadecyldimethyl (3-trimethoxysilylpropyl) ammonium chloride, n,n-didecyl-n-(3-trimethoxysilylpropyl) ammonium chloride, and mixtures thereof. Quaternary phosphonium silane analogs of the above quaternary ammonium silane compounds are also envisioned, and their chemical name would be arrived at by simply substituting “phosphonium” for “ammonium.”

In some embodiments, the zeta potential of the polishing composition can be at least about 20 mV. For example, the zeta potential of the polishing composition described herein can be at least about 25 mV (e.g., at least about 30 mV, at least about 35 mV, or at least about 40 mV) to at most about 60 mV (e.g., at most about 55 mV, at most about 50 mV, or at most about 45 mV). In more specific embodiments, the zeta potential of the polishing composition having a pH value between about 5 and about 12 (e.g., between about 7 and 12) can be at least about 20 mV. Without wishing to be bound by theory, it is believed that a zeta potential of at least about 20 mV of the polishing composition creates stronger electrostatic repulsion between abrasive particles, improves dispersion stability by preventing particle aggregation, and is difficult to achieve at higher pH values (e.g., alkaline pH values) opening new areas of application for cationically charged particles.

In some embodiments, the conductivity of the polishing composition can be at least about 15 mS/cm. For example, the conductivity of the polishing composition described herein can be at least about 20 mS/cm (e.g., at least about 25 mS/cm, at least about 30 mS/cm, or at least about 20 mS/cm) to at most about 45 mS/cm (e.g., at most about 40 mS/cm, at most about 35 mS/cm, or at most about 15 mS/cm). Without wishing to be bound by theory, it is believed that quaternary ammonium silane modified particles described herein are capable of maintaining their strong positive charge even at a pH values above about 7 even in high conductivity compositions (e.g., having a conductivity of at least about 15 mS/cm), thereby conferring an unexpectedly high stability to the compositions. Conductivity of the polishing composition of at least about 15 mS/cm may indicate a high ionic strength polishing composition that has high concentrations of dissolved ions. Abrasive dispersions in polishing compositions with this high of conductivity are commonly very unstable with low shelf life due to abrasive aggregation and settling. However, the chemically modified abrasives described herein show remarkably high stability in high conductivity compositions, leading to the ability to significantly dilute the composition to form a point of use (POU) polishing composition.

In some embodiments, the polishing compositions described herein can be substantially free of one or more of certain ingredients, such as organic solvents, pH adjusting agents, quaternary ammonium compounds (e.g., salts such as tetraalkylammonium salts or hydroxides such as tetraalkylammonium hydroxides, e.g., tetramethylammonium hydroxide or a salt thereof), quaternary phosphonium compounds (e.g., salts such as tetraalkylphosphonium salts or hydroxides such as tetraalkylphosphonium hydroxides) alkali bases (such as alkali hydroxides), bicarbonate salts (e.g., potassium bicarbonate or ammonium bicarbonate), carbonate salts (e.g., guanidine carbonate), fluorine containing compounds (e.g., fluoride compounds or fluorinated com-pounds (e.g., fluorinated polymers/surfactants)), silicon-containing compounds such as silanes (e.g., alkoxysilanes), nitrogen-containing compounds (e.g., amino acids, amines, imines (e.g., amidines such as 1,8-diazabicyclo[5.4.0]-7-undecene (DBU) and 1,5-diazabicyclo[4.3.0]non-5-ene (DBN)), amides, aminoalcohols, or imides), salts (e.g., halide salts or metal salts), polymers (e.g., nonionic, cationic, anionic, or water-soluble polymers), inorganic acids (e.g., hydrochloric acid, sulfuric acid, phosphoric acid, or nitric acid), surfactants (e.g., cationic surfactants, anionic surfactants, non-polymeric surfactants, or nonionic surfactants), plasticizers, oxidizing agents (e.g., H₂O₂ and/or periodic acid), corrosion inhibitors (e.g., azole or non-azole corrosion inhibitors), electrolytes (e.g., polyelectrolytes), dienoic acids (e.g., sorbic acid), polyethylene glycols (e.g., PEG 1000, PEG 2000, PEG 4000, or PEG 8000), health hazardous chemicals classified as GHS Category 1 or 2 (e.g., ethylene diamine, piperazine, 1,3-diaminopropane, imidazole, 1,2,4-triazole, or 3-amino-1,2,4-trizole), and/or compounds having a boiling point less than 50° C. (e.g., propylamine or isopropylamine). The halide salts that can be excluded from the compositions include alkali metal halides (e.g., sodium halides or potassium halides) or ammonium halides (e.g., ammonium chloride), and can be fluorides, chlorides, bromides, or iodides. As used herein, an ingredient that is “substantially free” from a polishing composition refers to an ingredient that is not intentionally added into the composition. In some embodiments, the polishing composition described herein can have at most about 2000 ppm (e.g., at most about 1000 ppm, at most about 500 ppm, at most about 250 ppm, at most about 100 ppm, at most about 50 ppm, at most about 10 ppm, or at most about 1 ppm) of one or more of the above ingredients. In some embodiments, the polishing composition described herein can be completely free of one or more of the above ingredients.

The following examples are intended to further illustrate the subject matter of this disclosure and should in no way be construed as limiting the disclosure.

### EXAMPLES OF THE DISCLOSURE

Examples are provided to further illustrate the capabilities of the methods of the present disclosure. The provided examples are not intended and should not be construed to limit the scope of the present disclosure. Any percentages listed are by weight (wt %) unless otherwise specified. The examples shown herein are representative and cannot encompass the complete broad scope of this invention disclosure.

### Example 1-Production of Colloidal Silica Particles Chemically Modified by Quaternary Ammonium Silane

A 50% by weight solution of a quaternary ammonium silane in methanol was diluted to a 25% by weight solution by the addition of ethanol. A 34% by weight solution of silica particles was subjected to agitation in the range of 500-700 rpm by an overhead stirrer and the pH of the solution was adjusted with addition of nitric acid until a stable pH of around 3.8 was achieved. Initially, and as supplied, the zeta-potential of the silica particles was about-25 mV but after adjusting the pH the zeta-potential of the silica particles was measured to be about 8 mV. At this point, the 25% by weight solution of quaternary ammonium silane dissolved in a water miscible solvent was added dropwise over a period of about four hours for an addition rate of about two grams solution per minute. In total, about 4% by weight of quaternary ammonium silane compound was added with respect to the total weight of silica in the starting silica solution. After completing the addition of the quaternary ammonium silane compound to the starting silica solution the pH value was about 5 and the zeta-potential of the particles was about 42 mV. The final silica concentration in the mixed solution was about 32% and the mean particle size (MPS) of the modified silica particles were measured to change by less than 2% with respect to the starting MPS. The isoelectric point for the non-modified colloidal silica (i.e., as supplied), the silica after modification with a quaternary ammonium silane, and a commercially available cationic colloidal silica are shown in Table 1 below.

TABLE 1

| Sample | Isoelectric Point |
|---|---|
| Non-modified Colloidal Silica | ~4 |
| Quaternary Ammonium Silane Modified | ~9.5 |
| Cationic Silica | |
| Commercially Available Cationic Silica | ~5 |

### Example 2-Polishing Composition Formulation and Stability

Three chemical mechanical planarization compositions were prepared using each of the particles described in Table 1 above. Each of the CMP compositions had a pH of about 7 and included an organic acid, an inorganic base and a silica at 2.5 weight percent. The amount of acids and bases used in the compositions were the same in all the samples and led to conductivity values of greater than 20 mS/cm. The compositions that used the non-modified colloidal silica and the commercially available cationic silica were highly unstable as evidenced by their gelation several hours after formulation. In contrast, the composition with quaternary ammonium silane modified particles exhibited stable mean particle size (MPS), zeta-potential of about 45 mV, and conductivity readings over a period of four weeks when stored in a 45° C. oven. The surprisingly high stability of the high conductivity composition with quaternary ammonium silane modified particles is likely a result of the ability of the particles to maintain their strong positive charge at a pH of about 7, whereas the other particles tested have lower isoelectric points and would not be strongly charged, leading to their fast aggregation and gelation in the unfavorable highly conductive environment.

### Example 3-Polishing Composition Performance

In this example, the polishing performance of compositions with quaternary ammonium silane modified particles were compared against commercially available CMP polishing compositions. The inventive composition used for the first four entries in Table 2 below (Silicon Carbide (SiC), Carbon Doped Silicon Oxide (SiOC), TEOS, and Ruthenium) had a pH of about 7 and included a chemically modified abrasive with a MPS of 40 nm, an inorganic acid, an organic base, and a triazole derivative. The commercially available composition had a pH of about 7 and included similar chemical components except for using a 70 nm non-modified abrasive. The polishing results are shown in Table 2 below.

TABLE 2

| | Commercially | Inventive Composition |
|---|---|---|
| | Available | with Quaternary |
| | Composition - | Ammonium Silane |
| | Removal Rate | Modified Abrasive - |
| Film Type Polished | in Å/min | Removal Rate in Å/min |
| Silicon Carbide | 10 | 42 |
| (SiC) | | |
| Carbon Doped Silicon | 3 | 39 |
| Oxide (SiOC) | | |
| TEOS | 84 | 211 |
| Ruthenium | 4 | 17 |
| — | — | — |
| Barrier Polishing | SiC - 45 | SiC - 54 |
| | Black Diamond - 770 | Black Diamond - 921 |
| | TEOS - 905 | TEOS - 826 |
| | Copper - 126 | Copper - 106 |
| | Ta - 408 | Ta - 320 |
| | TaN - 419 | TaN - 192 |
| | TiN - 937 | TiN - 155 |

The first four entries in Table 2 (SiC, SiOC, TEOS, and Ruthenium) were obtained using the same pairing of commercially available polish and inventive composition. Significantly, the inventive composition tested include ten times less abrasive by weight percent than the commercially available polish. Despite the significantly lower abrasive loading and smaller MPS, the inventive compositions were able to provide a much higher removal rate across a variety of film types.

The fifth entry in Table 2 (Barrier Polishing) used a commercial barrier polishing composition and an inventive composition that each included an abrasive with a MPS of about 70 nm. Again, the inventive composition tested included much less abrasive by weight percent (i.e. four times less abrasive) than the commercially available polish. Despite the significantly lower abrasive loading, the inventive composition was able to roughly match the performance of the commercial composition across the variety of film types encountered during a barrier polishing process. Interestingly, the removal rate for TIN film is substantially decreased with the chemically modified particles. This result is likely achieved because the TIN film has a positive charge at the pH value of the polishing composition and therefore the positively charged chemically modified particles are electrostatically repelled from the surface. Reliably achieving a low removal rate of TiN has been difficult to achieve simply through electrostatic repulsion of the abrasive because of a lack of abrasives that maintain their strong positive charge at a pH of about 7. Instead, chemical compounds that enable the inhibition of TiN removal are used and they can cause unpredictable off-target effects.

These results are unexpected because the abrasive provides the mechanical removal aspect involved in chemical mechanical planarization and using significantly less abrasive with similar other chemicals would be expected to result in a pronounced decrease in material removal rates. Without being bound by theory it is believed that the strong positive charge on the chemically modified abrasive in inventive compositions facilitates a greater interaction of the abrasive with the surfaces to be polished due to electrostatic interactions. Importantly, the reduction in abrasive loading required to achieve similar or better removal rate performance provides for instant cost savings and, when combined with the ability of the chemically modified abrasives to have high stability in highly conductive formulations, the ability to provide a highly concentrated formulation to an end user resulting in further cost savings through reduction in shipping and storage costs.

### Embodiments of the Disclosure

Although the present invention is defined in the claims, it should be understood that the present invention can also (alternatively) be defined in accordance with the following embodiments:

Embodiment 1. A method for chemically modifying metal oxide particles, comprising:
a) adjusting the pH of a liquid dispersion of metal oxide particles to a pH value where the zeta potential of the metal oxide particles is from at least about-20 mV to at most about 20 mV; and
b) adding a quaternary silane to the liquid dispersion of metal oxide particles to form chemically modified metal oxide particles.

Embodiment 2. The method of embodiment 1, wherein the metal oxide particles comprise silica, titania, alumina, ceria, zirconia, or mixtures thereof.

Embodiment 3. The method of embodiment 1, wherein the metal oxide particles comprise colloidal silica, fumed silica, core-shell particles comprising a silica shell, or mixtures thereof.

Embodiment 4. The method of any one of embodiments 1-3, wherein the metal oxide particles in the liquid dispersion have a mean particle size of from 1 nm to 5000 nm.

Embodiment 5. The method of any one of embodiments 1-4, wherein the liquid dispersion is an aqueous dispersion.

Embodiment 6. The method of any one of embodiments 1-5, wherein the liquid dispersion of metal oxide particles has a weight percent of from about 1% to about 50% by weight of the metal oxide particles.

Embodiment 7. The method of any one of embodiments 1-6, wherein after the adjusting, and prior to adding the quaternary silane, the pH of the liquid dispersion of the metal oxide particles is below the isoelectric point of the metal oxide particles.

Embodiment 8. The method of any one of embodiments 1-7, wherein the liquid dispersion of metal oxide particles has a pH from about 1 to about 7 after the adjusting.

Embodiment 9. The method of any one of embodiments 1-8, wherein an acid is added to the liquid dispersion of metal oxide particles during the adjusting.

Embodiment 10. The method of embodiment 9, wherein the acid is selected from the group consisting of formic acid, acetic acid, malonic acid, citric acid, propionic acid, malic acid, adipic acid, succinic acid, lactic acid, oxalic acid, hydroxyethylidene diphosphonic acid, 2-phosphono-1,2,4-butane tricarboxylic acid, aminotrimethylene phosphonic acid, hexamethylenediamine tetra(methylenephosphonic acid), bis(hexamethylene)triamine phosphonic acid, amino acetic acid, peracetic acid, phenoxyacetic acid, glycine, bicine, diglycolic acid, glyceric acid, tricine, histidine, phenylalanine, proline, aspartic acid, glutamic acid, arginine, benzoic acid, nitric acid, sulfuric acid, sulfurous acid, phosphoric acid, phosphonic acid, hydrochloric acid, periodic acid, tartaric acid, boric acid, phthalic acid, and mixtures thereof.

Embodiment 11. The method of any one of embodiments 1-10, wherein the quaternary silane is a silane compound that includes an ammonium group or a phosphonium group.

Embodiment 12. The method of any one of embodiments 1-11, wherein the quaternary silane is a silane compound that has a terminal ammonium group or a terminal phosphonium group.

Embodiment 13. The method of any one of embodiments 1-12, wherein the quaternary silane is selected from the group consisting of n-trimethoxysilylpropyl-n,n,n-trimethylammonium chloride, n-triethoxysilylpropyl-n,n,n-trimethylammonium chloride, n-trimethoxysilylethyl-n,n,n-trimethylammonium chloride, n-triethoxysilylethyl-n,n,n-trimethylammonium chloride, n-trimethoxysilylpropyl-n,n,n-triethylammonium chloride, n-triethoxysilylpropyl-n,n,n-triethylammonium chloride, n-trimethoxysilylethyl-n,n,n-tripropylammonium chloride, n-triethoxysilylethyl-n,n,n-tripropylammonium chloride octadecyldimethyl (3-trimethoxysilylpropyl) ammonium chloride, n,n-didecyl-n-(3-trimethoxysilylpropyl) ammonium chloride, and mixtures thereof.

Embodiment 14. The method of any one of embodiments 1-13, wherein the quaternary silane compound is added to the liquid dispersion of metal oxide particles after being dissolved in a water miscible solvent to form a water miscible solution.

Embodiment 15. The method of embodiment 14, wherein the quaternary silane is from about 0.1% to about 75% by weight of the water miscible solution.

Embodiment 16. The method of embodiment 14, wherein the water miscible solvent is selected from the group consisting of methanol, ethanol, propanol, iso-propanol, butanol, ethylene glycol, propylene glycol, acetone, toluene, dimethylformamide, tetrahydrofuran, or mixtures thereof.

Embodiment 17. The method of any one of embodiments 1-16, wherein adding the quaternary silane is performed while agitating the liquid dispersion of metal oxide particles.

Embodiment 18. The method of any one of embodiments 1-17, wherein adding the quaternary silane is performed at a consistent rate.

Embodiment 19. The method of any one of embodiments 1-18, wherein from about 0.1% to about 20% by weight of quaternary silane is added to the liquid dispersion with respect to the weight of metal oxide particles in the liquid dispersion.

Embodiment 20. The method of any one of embodiments 1-19, wherein the chemically modified metal oxide particles have an isoelectric point of at least 7.

Embodiment 21. The method of any one of embodiments 1-20, wherein the chemically modified metal oxide particles have a mean particle size from about 1% to at most about 20% different from the mean particle size of the metal oxide particles.

Embodiment 22. The method of any one of embodiments 1-21, wherein the weight percent of the chemically modified particles after the adding is at most 5% different from the weight percent of the metal oxide particles in the liquid dispersion.

Embodiment 23. A chemically modified metal oxide particle dispersion made by the method of any one of embodiments 1-22.

Embodiment 24. The chemically modified metal oxide particle dispersion of embodiment 23, wherein the chemically modified metal oxide particles in the dispersion have a mean particle size of from about 1 nm to about 100 nm.

Embodiment 25. A polishing composition comprising:
at least one abrasive comprising metal oxide particles; and
at least one acid or base;
an aqueous solvent;
wherein the metal oxide particles have been chemically modified with a quaternary silane compound and have a mean particle size less than about 100 nm; and
wherein the polishing composition has a conductivity of at least about 15 mS/cm and a zeta potential of at least about 20 mV.

Embodiment 26. The polishing composition of embodiment 25, wherein the metal oxide particles comprise silica, titania, alumina, ceria, zirconia, or mixtures thereof.

Embodiment 27. The polishing composition of embodiment 25, wherein the metal oxide particles comprise colloidal silica, fumed silica, core-shell particles comprising a silica shell, or mixtures thereof.

Embodiment 28. The polishing composition of any one of embodiments 25-27, wherein the metal oxide particles have a mean particle size of from about 1 nm to about 100 nm.

Embodiment 29. The polishing composition of any one of embodiments 25-28, wherein the metal oxide particles are from about 1% to about 40% by weight of the polishing composition.

Embodiment 30. The polishing composition of any one of embodiments 25-29, wherein the acid or base is from about 0.005% to about 0.5% by weight of the polishing composition.

Embodiment 31. The polishing composition of any one of embodiments 25-30, wherein the acid is selected from the group consisting of organic acids, inorganic acids, and mixtures thereof.

Embodiment 32. The polishing composition of any one of embodiments 25-30, wherein the base is selected from the group consisting of inorganic bases, organic bases, and any combinations thereof.

Embodiment 33. The polishing composition of any one of embodiments 25-32, wherein the quaternary silane compound is a silane compound that includes an ammonium group or a phosphonium group.

Embodiment 34. The polishing composition of any one of embodiments 25-33, wherein the quaternary silane compound is a silane compound that has a terminal ammonium group or a terminal phosphonium group.

Embodiment 35. The polishing composition of any one of embodiments 25-32, wherein the quaternary silane compound is selected from the group consisting of n-trimethoxysilylpropyl-n,n,n-trimethylammonium chloride, n-triethoxysilylpropyl-n,n,n-trimethylammonium chloride, n-trimethoxysilylethyl-n,n,n-trimethylammonium chloride, n-triethoxysilylethyl-n,n,n-trimethylammonium chloride, n-trimethoxysilylpropyl-n,n,n-triethylammonium chloride, n-triethoxysilylpropyl-n,n,n-triethylammonium chloride, n-trimethoxysilylethyl-n,n,n-tripropylammonium chloride, n-triethoxysilylethyl-n,n,n-tripropylammonium chloride octadecyldimethyl (3-trimethoxysilylpropyl) ammonium chloride, n,n-didecyl-n-(3-trimethoxysilylpropyl) ammonium chloride, and mixtures thereof.

Embodiment 36. The polishing composition of any one of embodiments 25-35, further comprising at least one corrosion inhibitor.

Embodiment 37. The polishing composition of embodiment 36, wherein the at least one corrosion inhibitor is selected from the group consisting of an azole, a pyrimidine, a purine, and mixtures thereof.

Embodiment 38. The polishing composition of any one of embodiments 25-37, wherein the at least one corrosion inhibitor is selected from the group consisting of tetrazole, benzotriazole, tolyltriazole, 1-methyl benzotriazole, 4-methyl benzotriazole, 5-methyl benzotriazole, 1-ethyl benzotriazole, 1-propyl benzotriazole, 1-butyl benzotriazole, 5-butyl benzotriazole, 1-pentyl benzotriazole, 1-hexyl benzotriazole, 5-hexyl benzotriazole, 5,6-dimethyl benzotriazole, 5-chloro benzotriazole, 5,6-dichloro benzotriazole, 1-(chloromethyl)-1H-benzotriazole, chloroethyl benzotriazole, phenyl benzotriazole, benzyl benzotriazole, aminotriazole, aminobenzimidazole, pyrazole, imidazole, aminotetrazole, adenine, xanthine, cytosine, thymine, uracil, 9H-purine, guanine, isoguanine, hypoxanthine, benzimidazole, thiabendazole, 1,2,3-triazole, 1,2,4-triazole, 1-hydroxybenzotriazole, 2-methylbenzothiazole, 2-aminobenzimidazole, 2-amino-5-ethyl-1,3,4-thiadiazole, 3,5-diamino-1,2,4-triazole, 3-amino-5-methylpyrazole, 4-amino-4H-1,2,4-triazole, and combinations thereof.

Embodiment 39. The polishing composition of any one of embodiments 25-38, wherein the at least one corrosion inhibitor is in an amount of from about 0.001% to about 5% by weight of the composition.

Embodiment 40. The polishing composition of any one of embodiments 25-39, wherein the conductivity of the polishing composition is between about 20 mS/cm and about 45 mS/cm.

Embodiment 41. The polishing composition of any one of embodiments 25-40, wherein the zeta potential of the polishing composition is between about 25 mV and about 60 mV.

Embodiment 42. The polishing composition of any one of embodiments 25-41, wherein the polishing composition has a pH value between about 5 and about 12.

Embodiment 43. The polishing composition of any one of embodiments 25-42, wherein the polishing composition is free of dispersants.

Embodiment 44. A method of polishing a substrate, comprising the steps of:
applying the polishing composition of any one of embodiments 25-43 to a surface of a substrate; and
bringing a pad into contact with the surface of the substrate and moving the pad in relation to the substrate.

Embodiment 45. The method of embodiment 44, wherein the substrate comprises silicon carbide, carbon-doped silicon oxide, tetraethyl orthosilicate, ruthenium, copper tantalum, or titanium.

Embodiment 46. A composition comprising metal oxide particles, wherein the particles comprise a quaternary silane, and wherein the particles have a mean particle size of from 1 nm to 100 nm.

Embodiment 47. The composition of embodiment 46, wherein the particles comprise silica, titania, alumina, ceria, zirconia, or mixtures thereof.

Embodiment 48. The composition of embodiment 46, wherein the metal oxide particles comprise colloidal silica, fumed silica, core-shell particles comprising a silica shell, or mixtures thereof.

Embodiment 49. The composition of any one of embodiments 46-48, wherein the quaternary silane is a silane compound that has a terminal ammonium group or a terminal phosphonium group.

Embodiment 50. The composition of any one of embodiments 46-49, wherein the composition is in the form of a liquid dispersion.

While this disclosure has been described with respect to the examples and embodiments set forth herein, it is understood that other modifications and variations are possible without departing from the spirit and scope of the disclosure as defined in the appended claims.

What is claimed is:

1. A method for chemically modifying metal oxide particles, comprising:
a) adjusting the pH of a liquid dispersion of metal oxide particles to a pH value where the zeta potential of the metal oxide particles is from at least about-20 mV to at most about 20 mV; and
b) adding a quaternary silane to the liquid dispersion of metal oxide particles to form chemically modified metal oxide particles.

2. The method of claim 1, wherein the metal oxide particles comprise silica, titania, alumina, ceria, zirconia, or mixtures thereof.

3. The method of claim 1, wherein the metal oxide particles comprise colloidal silica, fumed silica, core-shell particles comprising a silica shell, or mixtures thereof.

4. The method of claim 1, wherein the metal oxide particles in the liquid dispersion have a mean particle size of from 1 nm to 5000 nm.

5. The method of claim 1, wherein the liquid dispersion of metal oxide particles has a weight percent of from about 1% to about 50% by weight of the metal oxide particles.

6. The method of claim 1, wherein after the adjusting, and prior to adding the quaternary silane, the pH of the liquid dispersion of the metal oxide particles is below the isoelectric point of the metal oxide particles.

7. The method of claim 1, wherein the liquid dispersion of metal oxide particles has a pH from about 1 to about 7 after the adjusting.

8. The method of claim 1, wherein an acid is added to the liquid dispersion of metal oxide particles during the adjusting, wherein the acid is selected from the group consisting of inorganic acids, organic acids, and mixtures thereof.

9. The method of claim 1, wherein the quaternary silane is a silane compound that includes an ammonium group or a phosphonium group.

10. The method of claim 1, wherein the quaternary silane compound is added to the liquid dispersion of metal oxide particles after being dissolved in a water miscible solvent to form a water miscible solution, wherein the quaternary silane is from about 0.1% to about 75% by weight of the water miscible solution, and wherein the water miscible solvent is selected from the group consisting of methanol, ethanol, propanol, iso-propanol, butanol, ethylene glycol, propylene glycol, acetone, toluene, dimethylformamide, tetrahydrofuran, or mixtures thereof.

11. The method of claim 1, wherein adding the quaternary silane is performed while agitating the liquid dispersion of metal oxide particles, and wherein adding the quaternary silane is performed at a consistent rate.

12. The method of claim 1, wherein from about 0.1% to about 20% by weight of quaternary silane is added to the liquid dispersion with respect to the weight of metal oxide particles in the liquid dispersion.

13. The method of claim 1, wherein the chemically modified metal oxide particles have an isoelectric point of at least 7.

14. The method of claim 1, wherein the chemically modified metal oxide particles have a mean particle size from about 1% to at most about 20% different from the mean particle size of the metal oxide particles.

15. A polishing composition comprising:
at least one abrasive comprising metal oxide particles; and
at least one acid or base;
an aqueous solvent;
wherein the metal oxide particles have been chemically modified with a quaternary silane compound and have a mean particle size less than about 100 nm; and
wherein the polishing composition has a conductivity of at least about 15 mS/cm and a zeta potential of at least about 20 mV.

16. The polishing composition of claim 15, wherein the metal oxide particles comprise silica, titania, alumina, ceria, zirconia, or mixtures thereof.

17. The polishing composition of claim 15, wherein the metal oxide particles are from about 1% to about 40% by weight of the polishing composition.

18. The polishing composition of claim 15, wherein the quaternary silane compound is a silane compound that includes an ammonium group or a phosphonium group.

19. The polishing composition of claim 15, wherein the quaternary silane compound is selected from the group consisting of n-trimethoxysilylpropyl-n,n,n-trimethylammonium chloride, n-triethoxysilylpropyl-n,n,n-trimethylammonium chloride, n-trimethoxysilylethyl-n,n,n-trimethylammonium chloride, n-triethoxysilylethyl-n,n,n-trimethylammonium chloride, n-trimethoxysilylpropyl-n,n,n-triethylammonium chloride, n-triethoxysilylpropyl-n,n,n-triethylammonium chloride, n-trimethoxysilylethyl-n,n,n-tripropylammonium chloride, n-triethoxysilylethyl-n,n,n-tripropylammonium chloride octadecyldimethyl (3-trimethoxysilylpropyl) ammonium chloride, n,n-didecyl-n-(3-trimethoxysilylpropyl) ammonium chloride, and mixtures thereof.

20. The polishing composition of claim 15, wherein the conductivity of the polishing composition is between about 20 mS/cm and about 45 mS/cm.

21. The polishing composition of claim 15, wherein the zeta potential of the polishing composition is between about 25 mV and about 60 mV.

22. The polishing composition of claim 15, wherein the polishing composition has a pH value between about 5 and about 12.

23. The polishing composition of claim 15, wherein the polishing composition is free of dispersants.

24. A composition comprising metal oxide particles,
wherein the particles comprise a quaternary silane, and
wherein the particles have a mean particle size of from 1 nm to 100 nm.
